(19) United States
(12) Patent Application Publication
(10) Pub. No.: US 2013/0253676 A1
(43) Pub. Date: Sep. 26, 2013

(54) JACKPOT PUBLICATION SYSTEM AND METHOD

(71) Applicant: Lucien Maurice van Linden, Maasland (NL)

(72) Inventor: Lucien Maurice van Linden, Maasland (NL)

(21) Appl. No.: 13/850,252

(22) Filed: Mar. 25, 2013

Related U.S. Application Data
(60) Provisional application No. 61/619,323, filed on Apr. 2, 2012.
(60) Provisional application No. 61/615,162, filed on Mar. 23, 2012.

(51) Int. Cl. G07F 17/32

(52) U.S. Cl. CPC G07F 17/3258
USPC 700/91

(57) ABSTRACT

A jackpot publication system, including a jackpot data collection device connected with a plurality of gaming devices for received jackpot data including the current jackpot amount for all available jackpots and any current jackpot win, a communication device configured for transmitting the current jackpot wins and jackpot amounts for display through a global public network and a controller device for directing the communication device to display the jackpot amounts through the global public network upon the passage of the preset time interval and display current jackpot wins.

### CROSS-REFERENCE TO RELATED APPLICATIONS

This application claims the benefit of U.S. Provisional Patent Application Ser. No. 61/619,323, filed Apr. 2, 2012, and U.S. Provisional Patent Application Ser. No. 61/615,162, filed Mar. 23, 2012, the disclosures of which are incorporated herein by reference.

### BACKGROUND OF THE INVENTION

The invention relates generally to electronic gaming systems and methods, and more particularly, to an electronic gaming system that is configured for interacting with a global public network or communication system such as the Internet.

Wagering games, such as Blackjack, Pai Gow and Baccarat, and gaming machines made by gaming manufacturers to provide wagering opportunities, such as slot machines, have traditionally been found throughout casinos. These casinos consist of physical buildings located in specific geographic locations that are authorized to present wagering games to casino patrons. Most, if not all, casino operating companies spend significant resources on advertising and promotion to attract players to travel to and play at their casino.

The role of advertising and promotion in the gaming industry has always been essential to the sale and development of casino games and services. As times have changed, so too has the business of advertising and promotion. Unfortunately, many of the advertising and promotion used by casino operators and game manufacturers are not best-suited for use with modern modes of communication and content viewing.

As a result, a need exists for new approaches relating to the marketing, advertising and promotion in the gaming industry.

### SUMMARY OF THE INVENTION

The invention relates generally to a jackpot publication system, comprising: a jackpot data collection device connected with a plurality of gaming devices for received jackpot data, each gaming device of the plurality of the gaming devices being operable to award one or more randomly generated jackpots to players, wherein the jackpot collection device is configured for receiving jackpot data from each of the plurality of gaming devices, the jackpot data including the current jackpot amount for all available jackpots and any current jackpot win; a communication device configured for transmitting the current jackpot wins and jackpot amounts for one or more gaming devices of the plurality of gaming devices for public display through a global public network; and a controller device for comparing the timing of the jackpot data received with a preset time interval and directing the communication device to display the jackpot amounts through the global public network upon the passage of the preset time interval and display the current jackpot win upon receipt.

In some embodiments, the jackpot publication system further comprises a user interface in communication with the controller device for selecting the one or more gaming devices of the plurality of gaming devices. The user interface permits selection of a variety of features relating to the communication of the jackpot data, including the timing for communicating the jackpot amounts.

In some embodiments, the controller device is further configured to cause the display of the jackpot amounts and current jackpot wins on a preset Internet site.

In some embodiments, the jackpot data collection device is configured to receive jackpot data continuously.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a schematic representation of an exemplary system of the invention illustrating some of the operative components for providing the features described herein, among other things.

### DETAILED DESCRIPTION OF VARIOUS EMBODIMENTS OF THE INVENTION

In the following description, numerous specific details are set forth to provide a thorough understanding of the concepts underlying the described embodiments. It will be apparent, however, to one skilled in the art that the described embodiments may be practiced without some or all of these specific details. In other instances, well known process steps and computer components have not been described in detail in order to avoid unnecessarily obscuring the underlying concepts.

The invention is generally directed to systems and methods for reporting or publishing jackpot information to remote locations, that is, outside of a gaming establishment or online casino, and in particular, reporting jackpot information through social media applications, such as a casino operator or player-specified locations, including their respective “facebook” pages or “twitter” accounts, or through other general gaming locations online, or through mobile applications for players that subscribe or otherwise indicate they wish to receive jackpot information, or a user specified locations, such as a facebook page or twitter account managed by a marketing group on behalf of a gaming operator, among others.

In some embodiments, current jackpot values are recorded or collected, and automatically published to these various social media forms for purposes of creating interest in the underlying game, gaming establishment or online casino involved in the jackpot. For example, high jackpot values may be published to these social media forms for potential players located within a particular geographical range or for those who sign up to receive such updates. In other embodiments, an operator and/or player winning a jackpot may wish to publish the jackpot win through one or more social media forms. In some embodiments, the jackpot information may automatically be associated with these social media forms indicated in a player loyalty system maintained by a casino operator.

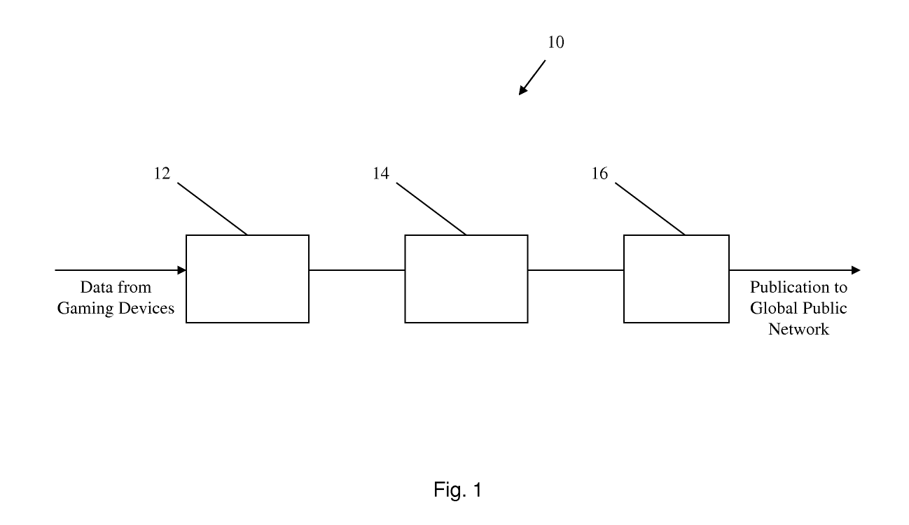

FIG. 1 illustrates an exemplary embodiment of a jackpot publication system of the invention generally identified by the reference numeral 10. System 10 includes a data collection device 12 which is connected with a plurality of gaming devices and configured for collecting jackpot data from the plurality of gaming devices. It should be understood that the connection may be accomplished through any conventional wired or wireless methods, so long as the jackpot data information is accessible to device 12. The jackpot data may include all information relating to the jackpots available at each gaming device, such as the jackpot amount, number of jackpots available and last won information. The jackpot data may also include game play information such as the rate of play of the game, game participation over an interval of time and information that may relate to the likelihood of a potential win. In addition, jackpot data includes information relating to any recent jackpots won.

For purposes of the invention, gaming devices may include any device which is capable of digitally recording jackpot or game play information, such as, but not limited to, slot machines, video poker machines, card-reading shoes or shuffling machines, intelligent table systems, multiplayer gaming platforms and the like.

Information received by data collection device 12 will be processed by a controller 14 through one or more processors and compared with preset notification criteria which may be stored in memory associated with controller 14 that outlines the transmittal of the jackpot data through a communication device 16.

Communication device 16 is configured to transmit the jackpot data, or portions thereof as determined by controller 14, for publication through a global public network, such as the Internet or satellite network. Communication device may connect with the global public network through any conventional means, wired or wireless, such as DSL or through satellite, for example.

For example, controller 14 may be configured to cause communication device 16 to publish periodic updates of jackpot information, including the most current jackpots amounts and indicate when a jackpot win occurs on a particular website, such as social media site which is either owned or operated by a casino operator. Controller 14 may control the storage in memory of any such websites and post information accordingly. Communication device 16 may be further configured to publish information through SMS, MMS or other messaging to mobile platforms which include the jackpot data.

A user interface (not shown) may be provided for purposes of controlling the transmission websites, particular gaming devices and intervals for transmitting the jackpot data. For example, the user may indicate that jackpots of at least a particular amount should be transmitted and that jackpot updates and availability should be transmitted at regular intervals of time or at particular times of the day.

The user interface of the invention may provide be configured as various graphical user interfaces which may be presented on a display, such as a computer display. Graphical user interfaces which may be employed may generally incorporate user-friendly features and fit seamlessly with other operating system interfaces, that is, in a framed form having borders, multiple folders, toolbars with pull-down menus, embedded links to other screens and various other selectable features associated with animated graphical representations of depressible buttons. These features can be selected (i.e., “clicked on”) by the user via connected mouse, keyboard, or other commonly used tool for indicating a preference in a computerized graphical interface.

It should be understood that methods and systems such as those described herein may be adapted and configured to function independently or may also interact with other systems or applications, such as for example, a casino management system or player tracking system. For example, the jackpot data may also include player information retrieved through the player identification received by the gaming device, such as through the use of a player reward card. This information may be used to further track the player's game play and provide additional points or identify a jackpot winning player through communication device 16 on the global public network as set by controller 14. Alternatively, a jackpot winning player may be presented with a choice to identify with themselves on the casino operator's site and perhaps receive additional benefits and/or identify a global public network or website, such as their own social media site page, for purposes of having communication device 16 transmit jackpot win information to that selected site.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database or memory device, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database.

This written description uses examples to disclose the invention and also to enable any person skilled in the art to practice the invention, including making and using the devices, apparatus or systems disclosed herein. Those skilled in the art will readily appreciate that the invention may include various computer and network related software and hardware, such as programs, operating systems, memory storage devices, data input/output devices, data processors, servers with links to data communication systems, wireless or otherwise, and data transceiving devices. It should also be understood that the communication, receiving or displaying of data, may further include or involve the transmission, receipt and processing of data through conventional hardware and/or software technology to effectuate the operations as described herein. Those skilled in the art will further appreciate that the precise types of software and hardware used are not vital to the full implementation of the methods of the invention so long as players and/or operators thereof are provided with useful access thereto.

While exemplary apparatus, systems and methods of the invention have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth by the claims and any equivalents thereto.

What is claimed is:

1. A jackpot publication system, comprising:
a) a jackpot data collection device connected with a plurality of gaming devices for received jackpot data, each gaming device of the plurality of the gaming devices being operable to award one or more randomly generated jackpots to players, wherein the jackpot collection device is configured for receiving jackpot data from each of the plurality of gaming devices, the jackpot data including the current jackpot amount for all available jackpots and any current jackpot win;
b) a communication device configured for transmitting the current jackpot wins and jackpot amounts for one or more gaming devices of the plurality of gaming devices for display through a global public network; and
c) a controller device for comparing the timing of the jackpot data received with a preset time interval and directing the communication device to display the jackpot amounts through the global public network upon the passage of the preset time interval and display the current jackpot win upon receipt by the jackpot data collection device.

2. A jackpot publication system as recited in claim 1, further comprising a user interface in communication with the controller device for selecting the one or more gaming devices of the plurality of gaming devices.

3. A jackpot publication system as recited in claim 2, wherein the user interface permits selection of the timing for communicating the jackpot amounts.

4. A jackpot publication system as recited in claim 1, wherein the controller device is further configured to cause the display of the jackpot amounts and current jackpot wins on a preset Internet site.

5. A jackpot publication system as recited in claim 1, wherein the jackpot data collection device is configured to receive jackpot data continuously.
